(19) United States
(12) Patent Application Publication
(10) Pub. No.: US 2025/0117581 A1
(43) Pub. Date: Apr. 10, 2025

(54) DOCUMENT CLASSIFICATION APPARATUS, DOCUMENT CLASSIFICATION METHOD, AND STORAGE MEDIUM

(71) Applicant: NEC Corporation, Minato-ku, Tokyo (JP)

(72) Inventors: Masafumi OYAMADA, Tokyo (JP); Taro YANO, Tokyo (JP); Kunihiro TAKEOKA, Tokyo (JP); Kosuke AKIMOTO, Tokyo (JP)

(73) Assignee: NEC Corporation, Minato-ku, Tokyo (JP)

(21) Appl. No.: 18/729,950

(22) PCT Filed: Jan. 25, 2022
(86) PCT No.: PCT/JP2022/002597

§ 371 Date: Jul. 18, 2024

(51) Int. Cl. G06F 40/279; G06F 40/40

(52) U.S. Cl. CPC G06F 40/279; G06F 40/40

(57) ABSTRACT

In order to classify, stably with high accuracy, a document to be classified, a document classification apparatus (1) includes: a strategy selection section (11) that selects at least one generation strategy from among a plurality of generation strategies for generating a hypothetical sentence related to a candidate classification as which a document is to be classified; a hypothetical sentence generation section (12) that generates, in accordance with the at least one generation strategy selected by the strategy selection section (11), the hypothetical sentence, which is a sentence related to the candidate classification; and a classification section (13) that determines, on the basis of entailment between the document and the hypothetical sentence, a classification as which the document is to be classified.

### TECHNICAL FIELD

The present invention relates to, for example, a document classification apparatus that automatically classifies a document.

### BACKGROUND ART

A large amount of data of various contents has recently been collected and accumulated. This requires a technique for automatically classifying such data. For example, Non-patent Literature 1 below discloses a technique for automatically associating a label with text by a method called zero-shot classification.

More specifically, according to the technique of Non-patent Literature 1, first, a premise sentence is generated from text to be classified, and a hypothetical sentence related to a label of a candidate classification is also generated. Then, by inputting the generated premise sentence and the generated hypothetical sentence into an entailment model, a degree to which the label matches the text to be classified is determined. The entailment model is a model constructed by machine learning whether a premise sentence entails a hypothetical sentence, i.e., whether the premise sentence includes the same content as the hypothetical sentence.

### CITATION LIST

### Non-Patent Literature

### [Non-patent Literature 1]

Wenpeng Yin, Jamaal Hay, Dan Roth, “Benchmarking Zero-shot Text Classification: Datasets, Evaluation and Entailment Approach”, arXiv: 1909.00161v1 [cs. CL], Aug. 31, 2019

### SUMMARY OF INVENTION

### Technical Problem

In the technique Literature 1, of Non-patent determination accuracy is affected depending on what a hypothetical sentence corresponding to each label is like, and there is room for improvement in accuracy and stability of classification. For example, regarding a label “sport”, a case where a hypothetical sentence “This is a sentence concerning sport.” is generated and a case where a hypothetical sentence “This refers to a topic of sport.” is generated differ in output value from an entailment model. Thus, even the same label “sport” results in different results of determination of a matching degree depending on which hypothetical sentence is generated.

An example aspect of the present invention has been made in view of such a problem, and an example object thereof is to provide a technique that makes it possible to classify, stably with high accuracy, a document to be classified.

### Solution to Problem

A document classification apparatus according to an example aspect of the present invention includes: a strategy selection means that selects at least one generation strategy from among a plurality of generation strategies for generating a hypothetical sentence related to a candidate classification as which a document is to be classified; a hypothetical sentence generation means that generates, in accordance with the at least one generation strategy selected by the strategy selection means, the hypothetical sentence, which is a sentence related to the candidate classification; and a classification means that determines, on the basis of entailment between the document and the hypothetical sentence, a classification as which the document is to be classified.

A document classification method according to an example aspect of the present invention includes: (a) selecting at least one generation strategy from among a plurality of generation strategies for generating a hypothetical sentence related to a candidate classification as which a document is to be classified; (b) generating, in accordance with the selected at least one generation strategy, the hypothetical sentence, which is a sentence related to the candidate classification; and (c) determining, on the basis of entailment between the document and the hypothetical sentence, a classification as which the document is to be classified, (a), (b), and (c) each being carried out by at least one processor.

A document classification program according to an example aspect of the present invention causes a computer to function as: a strategy selection means that selects at least one generation strategy from among a plurality of generation strategies for generating a hypothetical sentence related to a candidate classification as which a document is to be classified; a hypothetical sentence generation means that generates, in accordance with the at least one generation strategy selected by the strategy selection means, the hypothetical sentence, which is a sentence related to the candidate classification; and a classification means that determines, on the basis of entailment between the document and the hypothetical sentence, a classification as which the document is to be classified.

### Advantageous Effects of Invention

An example aspect of the present invention makes it possible to classify, stably with high accuracy, a document to be classified.

### BRIEF DESCRIPTION OF DRAWINGS

FIG. 1 is a block diagram illustrating a configuration of a document classification apparatus according to a first example embodiment of the present invention.

FIG. 2 is a flowchart showing a flow of a document classification method according to the first example embodiment of the present invention.

FIG. 3 is a view illustrating an example of classification of a document by a document classification method according to a second example embodiment of the present invention.

FIG. 4 is a block diagram illustrating a configuration of a document classification apparatus according to the second example embodiment of the present invention.

FIG. 5 is a view illustrating an example of a generation strategy stored in a generation strategy holding section.

FIG. 6 is a view illustrating a method for generating a language understanding model.

FIG. 7 is a view illustrating an example of history information.

FIG. 8 is a flowchart showing a flow of a process carried out by the document classification apparatus.

FIG. 9 is a view illustrating an example of a computer that executes instructions of a program that is software realizing functions of apparatuses according to example embodiments of the present invention.

### Example Embodiments

### First Example Embodiment

The following description will discuss a first example embodiment of the present invention in detail with reference to the drawings. The present example embodiment is an embodiment serving as a basis for example embodiments described later.

(Configuration of document classification apparatus)

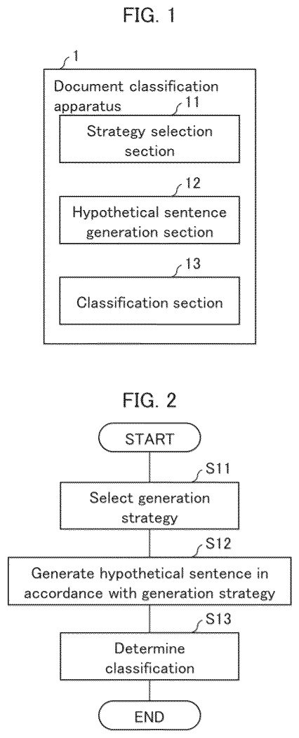

The following description will discuss, with reference to FIG. 1, a configuration of a document classification apparatus 1 according to the present example embodiment. FIG. 1 is a block diagram illustrating the configuration of the document classification apparatus 1. The document classification apparatus 1 includes a strategy selection section 11, a hypothetical sentence generation section 12, and a classification section 13 as illustrated in FIG. 1.

The strategy selection section 11 selects at least one generation strategy from among a plurality of generation strategies for generating a hypothetical sentence related to a candidate classification as which a document is to be classified.

The hypothetical sentence generation section 12 generates, in accordance with the at least one generation strategy selected by the strategy selection section 11, the hypothetical sentence, which is a sentence related to the candidate classification.

The classification section 13 determines, on the basis of entailment between the document and the hypothetical sentence, a classification as which the document is to be classified.

As described above, a configuration is employed such that the document classification apparatus 1 according to the present example embodiment includes: the strategy selection section 11 that selects at least one generation strategy from among a plurality of generation strategies for generating a hypothetical sentence related to a candidate classification as which a document is to be classified; the hypothetical sentence generation section 12 that generates, in accordance with the at least one generation strategy selected by the strategy selection section 11, the hypothetical sentence, which is a sentence related to the candidate classification; and the classification section 13 that determines, on the basis of entailment between the document and the hypothetical sentence, a classification as which the document is to be classified. This configuration makes it possible to classify, stably with high accuracy, a document to be classified.

### (Document Classification Program)

The foregoing functions of the document classification apparatus 1 can also be realized by a program. A document classification program according to the present example embodiment causes a computer to function as: a strategy selection means that selects at least one generation strategy from among a plurality of generation strategies for generating a hypothetical sentence related to a candidate classification as which a document is to be classified; a hypothetical sentence generation means that generates, in accordance with the at least one generation strategy selected by the strategy selection means, the hypothetical sentence, which is a sentence related to the candidate classification; and a classification means that determines, on the basis of entailment between the document and the hypothetical sentence, a classification as which the document is to be classified. This document classification program makes it possible to classify, stably with high accuracy, a document to be classified.

### (Flow of Document Classification Method)

The following description will discuss, with reference to FIG. 2, a flow of a document classification method according to the present example embodiment. FIG. 2 is a flowchart showing the flow of the document classification method. Note that steps of this document classification method may be carried out by a processor of the document classification apparatus 1 or by a processor of another apparatus. Alternatively, the steps may be carried out by processors provided in respective different apparatuses.

In S11, at least one processor selects at least one generation strategy from among a plurality of generation strategies for generating a hypothetical sentence related to a candidate classification as which a document is to be classified.

In S12, the at least one processor generates, in accordance with the selected at least one generation strategy, the hypothetical sentence, which is a sentence related to the candidate classification.

In S13, the at least one processor determines, on the basis of entailment between the document and the hypothetical sentence, a classification as which the document is to be classified.

As described above, a document classification method according to the present example embodiment includes: (a) selecting at least one generation strategy from among a plurality of generation strategies for generating a hypothetical sentence related to a candidate classification as which a document is to be classified; (b) generating, in accordance with the selected at least one generation strategy, the hypothetical sentence, which is a sentence related to the candidate classification; and (c) determining, on the basis of entailment between the document and the hypothetical sentence, a classification as which the document is to be classified, (a), (b), and (c) each being carried out by at least one processor. This document classification method makes it possible to classify, stably with high accuracy, a document to be classified.

### Second Example Embodiment

The following will discuss a second example embodiment of the present invention in detail with reference to the drawings.

### (Overview of Document Classification Method)

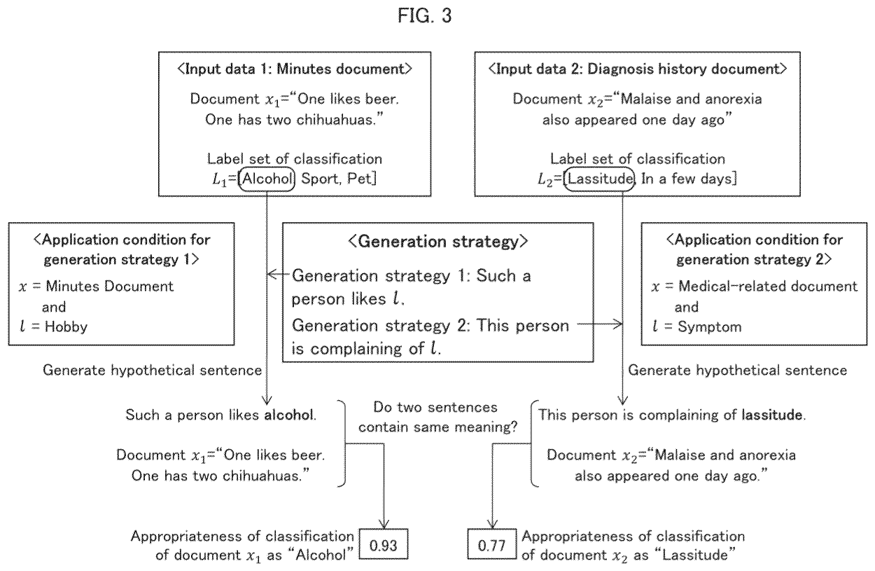

The following description will discuss, with reference to FIG. 3, an overview of a document classification method according to the present example embodiment (hereinafter referred to as the present method). FIG. 3 is a view illustrating an example of classification of a document by the present method. In the example of FIG. 3, a document x₁ and a label set L₁ serving as a candidate classification as which the document x₁ is to be classified are given as input data 1, and a document x₂ and a label set L₂ serving as a candidate classification as which the document x₂ is to be classified are given as input data 2.

Note that the classification can also be called a topic and that classification of the document x can also be referred to as a process for estimating a topic of the document x. Further, in a case where the document x is extracted from a conversation sentence and the label set L is a set of labels indicating an emotion of a speaker, classification of the document x can be rephrased as estimation of the emotion of the speaker. Furthermore, in a case where the label set L is a set of labels indicating a situation, classification of the document x can also be rephrased as estimation of the situation indicated by the document x.

The document x₁ included in the input data 1 is a document to be classified, and is a minutes document extracted from a minutes of, for example, a meeting. Specifically, the document x₁ is text data “One likes beer. One has two Chihuahuas.” The label set L₁ indicates a candidate classification as which the document x₁ is to be classified. The label set L₁ illustrated in FIG. 3 includes three candidates, i.e., alcohol, sport, and a pet. In FIG. 3, it is evaluated whether “alcohol” (hereinafter referred to as a candidate 11) among these candidates is appropriate as a classification as which the document x₁ is to be classified.

In the present method, in a case where the above-described evaluation is carried out, first, at least one generation strategy is selected from among a plurality of generation strategies for generating a hypothetical sentence related to a candidate classification. In the example of FIG. 3, one generation strategy is selected from among two generation strategies, i.e., generation strategies 1 and 2.

Note here that a generation strategy is a strategy for generating a hypothetical sentence related to a candidate classification. The generation strategy illustrated in FIG. 3 is a hypothetical sentence template on the basis of which a hypothetical sentence is generated by incorporation of a character string of a candidate classification. Specifically, the generation strategy 1 is text data “Such a person likes 1.”. A hypothetical sentence is generated by incorporating a character string of a candidate classification into the “1” part of this text data. Same applies to the generation strategy 2.

Further, as illustrated in FIG. 3, an application condition is defined for the generation strategy 1. The application condition is that the document x to be classified is a minutes document and that a candidate classification 1 is related to a hobby. The document x₁ illustrated in FIG. 3 is a minutes document, and the candidate 11 is “alcohol” and is related to a hobby. This satisfies the above-described application condition for the generation strategy 1. Thus, in the present method, a hypothetical sentence “Such a person likes alcohol.” related to the candidate 11, i.e., “alcohol” is generated in accordance with the generation strategy 1.

Next, in the present method, entailment between a hypothetical sentence and a document is evaluated. In the example of FIG. 3, it is evaluated whether the document x₁ to be classified, i.e., “One likes beer. One has two Chihuahuas.” entails the hypothetical sentence “Such a person likes alcohol.”, and an evaluation result of 0.93 is obtained.

Though details will be discussed in “Language understanding model” described later, this numerical value indicates a degree to which the document x₁ entails the hypothetical sentence, and a value closer to 1 means that the degree is higher. The numerical value is hereinafter referred to as an entailment score. Note that the degree to which the document x₁ entails the hypothetical sentence can be rephrased as a degree of possibility that the document x₁ entails the hypothetical sentence. Note also that the degree to which the document x₁ entails the hypothetical sentence can be alternatively rephrased as a degree of possibility that the content of the hypothetical sentence is correct when the document x₁ is regarded as a premise sentence.

In a case where the hypothetical sentence and the document x₁ to be classified contain the same meaning, or in a case where it can be said that the content of the hypothetical sentence is correct when the document x₁ is regarded as the premise sentence, it can be said that a candidate classification 11 related to the hypothetical sentence is highly likely to match the document x₁ to be classified. Thus, it can also be said that the entailment score indicates appropriateness of classification of the document x₁ to be classified as the candidate classification 11.

For example, the hypothetical sentence “Such a person likes alcohol.” and the document x₁ to be classified have an entailment score of 0.93. The entailment score of 0.93 is close to its maximum value of 1. Thus, this entailment score indicates that the document x₁ is highly likely to entail the above hypothetical sentence. This entailment score also indicates that it is highly appropriate to classify the document x₁ as the candidate classification 11 “alcohol” on which the hypothetical sentence “Such a person likes alcohol.” is based.

In contrast, the document x₂ included in the input data 2 is a diagnosis history document extracted from a diagnosis history in, for example, a hospital. Specifically, the document x₂ is text data “Malaise and anorexia also appeared one day ago.”. The label set L₂ indicates a candidate classification as which the document x₂ is to be classified. The label set L₂ illustrated in FIG. 3 includes two candidates, i.e., lassitude and in a few days. In FIG. 3, it is evaluated whether “lassitude” (hereinafter referred to as a candidate 12) among these candidates is appropriate as a classification as which the document x₂ is to be classified.

An application condition is also determined for the generation strategy 2 as in the case of the generation strategy 1. The application condition is that the document x to be classified is a medical-related document and that the candidate classification 1 is related to a symptom. The document x₂ illustrated in FIG. 3 is a diagnosis history document, i.e., a medical-related document, and the candidate 12 is “lassitude” and is related to a symptom. This satisfies the above-described application condition for the generation strategy 2. Thus, in the present method, a hypothetical sentence “This person is complaining of lassitude.” related to “lassitude” is generated in accordance with the generation strategy 2.

After the hypothetical sentence is generated, evaluation is carried out as in the case of the input data 1. That is, it is evaluated whether the document x₂ to be classified, i.e., “Malaise and anorexia also appeared one day ago.” entails the hypothetical sentence “This person is complaining of lassitude.”. An evaluation result for this is 0.77 and is substantially in accordance with a feeling about whether a person feels it appropriate to classify the document x₂ as “lassitude”.

As described above, according to the present method, a hypothetical sentence generated in accordance with a generation strategy selected from among a plurality of generation strategies is generated. This makes it possible to accurately evaluate, with use of a hypothetical sentence generated in accordance with an appropriate generation strategy, appropriateness of classification of a document as a candidate classification. Assume, for example, that a hypothetical sentence for the above-described input data 2 is generated by mechanically applying the generation strategy 1 without applying the present method. In this case, the generated hypothetical sentence is “Such a person likes lassitude.”, which is unnatural, and accuracy of an evaluation result for appropriateness is considered to be lower as compared with a case where the present method is applied.

It is possible to properly classify the document x₁, x₂ by carrying out the above-described process with respect to each of candidate classifications included in the label set L₁, L₂. For example, a candidate that has an entailment score which exceeds a preset threshold may be automatically determined as a classification. Alternatively, a display apparatus or the like may be caused to output an entailment score of each of candidates so as to allow a user to select a candidate to be employed as a classification as which the document x₁, x₂ is to be classified. Note that a plurality of classifications may be determined for one document. For example, two classifications, i.e., “alcohol” and “pet” may be determined for the document x₁ in FIG. 3.

A determined classification need only be recorded in association with the document x₁, x₂. The document x₁, x₂ with which information indicating a classification is associated is more widely used and utilized, for example such that it is possible to carry out, for example, search with use of the classification. Further, the document x₁, x₂ with which the information indicating a classification is associated can also be used as training data for machine learning a classification as which a document is to be classified.

### (Configuration of Document Classification Apparatus)

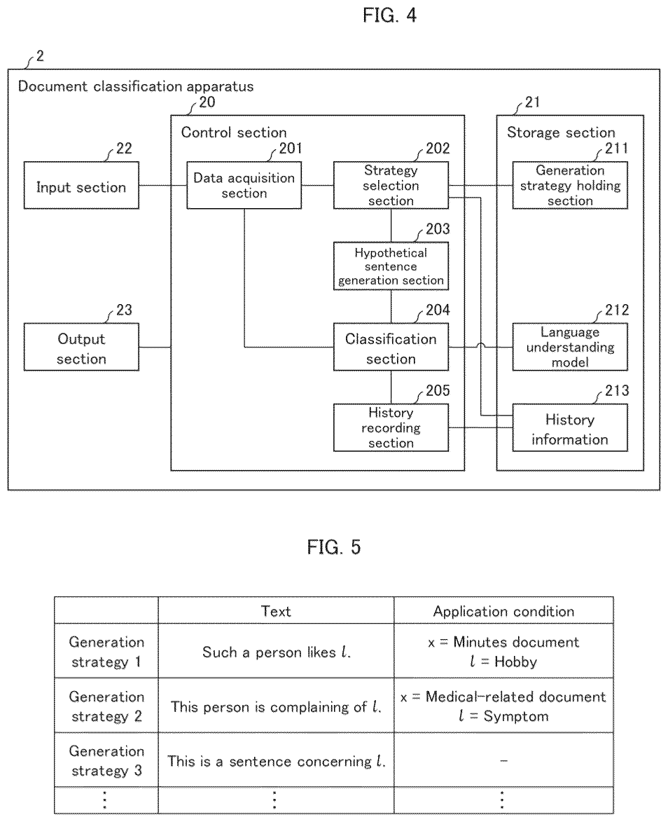

The following description will discuss, with reference to FIG. 4, a configuration of a document classification apparatus 2 according to the present example embodiment. FIG. 4 is a block diagram illustrating the configuration of the document classification apparatus 2. The document classification apparatus 2, which is an apparatus for classifying a document, includes, as illustrated in the drawing, a control section 20 that collectively controls sections of the document classification apparatus 2 and a storage section 21 that stores various kinds of data used by the document classification apparatus 2. The document classification apparatus 2 also includes an input section 22 that receives an input operation carried out by a user with respect to the document classification apparatus 2 and an output section 23 that allows the document classification apparatus 2 to output data. Note that the document classification apparatus 2 may be a dedicated apparatus for classification of a document or a general-purpose apparatus that can be used for applications other than classification of a document.

The control section 20 includes a data acquisition section 201, a strategy selection section (strategy selection means) 202, a hypothetical sentence generation section (hypothetical sentence generation means) 203, a classification section (classification means) 204, and a history recording section (history recording means) 205. The storage section 21 includes a generation strategy holding section 211 and stores a language understanding model 212 and history information 213. Note that the history recording section 205 and the history information 213 will be discussed in “Generation strategy selection method based on history information” described later.

The data acquisition section 201 acquires a document to be classified. The data acquisition section 201 also acquires a candidate classification as which the document is to be classified. For example, the data acquisition section 201 may acquire, as the document to be classified, text data that has been input via the input section 22, and may acquire, as the candidate classification, a label set that has been input also via the input section 22.

The strategy selection section 202 selects at least one generation strategy from among a plurality of generation strategies for generating a hypothetical sentence related to a candidate classification as which a document is to be classified. More specifically, the strategy selection section 202 selects at least one generation strategy from among generation strategies recorded in the generation strategy holding section 211 of the storage section 21. A method for selecting the generation strategy will be discussed in detail in “Generation strategy and generation strategy selection method” described later.

The hypothetical sentence generation section 203 generates the hypothetical sentence, which is a sentence related to the candidate classification as which the document is to be classified. More specifically, the hypothetical sentence generation section 203 generates the hypothetical sentence, in accordance with the at least one generation strategy selected by the strategy selection section 202, from the candidate classification acquired by the data acquisition section 201.

The classification section 204 determines, on the basis of entailment between the document to be classified and the hypothetical sentence related to the candidate classification as which the sentence is to be classified, a classification as which the document to be classified is to be classified. More specifically, the classification section 204 inputs, into the language understanding model 212 stored in the storage section 21, a set of a hypothetical sentence and a document which set is to be evaluated, calculates an entailment score, which is an index value indicating appropriateness of classification of the document as a candidate classification corresponding to the hypothetical sentence, and uses this entailment score to determine a classification. Note that the entailment score can be said to indicate a classification as which the document to be classified is to be classified. Thus, the classification section 204 may output the entailment score as information indicating the classification as which the document to be classified is to be classified. The language understanding model 212 will be discussed in detail in “Language understanding model” described later.

As described above, a configuration is employed such that the document classification apparatus 2 according to the present example embodiment includes: the strategy selection section 202 that selects at least one generation strategy from among a plurality of generation strategies for generating a hypothetical sentence related to a candidate classification as which a document to be classified is to be classified; the hypothetical sentence generation section 203 that generates, in accordance with the at least one generation strategy selected by the strategy selection section 202, the hypothetical sentence, which is a sentence related to the candidate classification; and the classification section 204 that determines, on the basis of entailment between the document to be classified and the hypothetical sentence, a classification as which the document to be classified is to be classified. This configuration brings about an example advantage of making it possible to stably obtain a classification result with highly accurate appropriateness.

Note that the document to be classified need only be a character string having some meaning, and is not particularly limited in content, form, or language. Note also that a source of the document to be classified is also not particularly limited. For example, a character string extracted from, for example, a minutes of, for example, a meeting, a questionnaire result, or a post on, for example, a social networking service (SNS) may be used as the document to be classified. Alternatively, a document indicating speech content converted into text by voice recognition may be used as the document to be classified. Further alternatively, text extracted from a data source such as various databases may be used as it is as the document to be classified, or a premise sentence generated from the extracted text may be used as the document to be classified.

### (Generation Strategy and Generation Strategy Selection Method)

FIG. 5 is a view illustrating an example of a generation strategy stored in the generation strategy holding section 211. A table illustrated in FIG. 5 includes generation strategies 1 to 3. The generation strategy 1 is text data “Such a person likes 1.”. A hypothetical sentence is generated by incorporating a character string of a candidate classification into the “1” part of this text data. Same applies to the generation strategies 2 and 3. By preparing such a generation strategy, the hypothetical sentence generation section 203 can easily generate a hypothetical sentence related to the candidate classification.

Further, the table illustrated in FIG. 5 shows application conditions for the respective generation strategies. For example, the application condition for the generation strategy 1 is that the document x to be classified is a minutes document and that the candidate classification 1 is related to a hobby. As described above, in a case where a generation strategy and an application condition for the generation strategy are recorded in association with each other, the strategy selection section 202 can select the generation strategy that satisfies the application condition. Such a generation strategy selection method is a selection method in accordance with a predefined condition, i.e., a rule, and thus can be said to be a selection method using a rule base.

Note that attribute information indicating what type of document the document x to be classified is may be associated in advance, as, for example, meta information, with the document x. Alternatively, the attribute information may be automatically generated from, for example, a word included in the document x. Same applies to attribute information of the candidate classification 1.

As described above, in a case where the document to be classified satisfies a predetermined condition, and the candidate classification satisfies a predetermined condition, the strategy selection section 202 may select a generation strategy that corresponds to those predetermined conditions. This makes it possible to select a generation strategy suitable for both the document to be classified and the candidate classification.

Further, in a case where at least one of the document and the candidate classification satisfies a predetermined condition, the strategy selection section 202 may select a generation strategy that corresponds to the predetermined condition. This configuration brings about not only an example advantage brought about by the document classification apparatus 1 according to the first example embodiment but also an example advantage of making it possible to select a generation strategy suitable for at least one of the document to be classified and the candidate classification.

As a matter of course, instead of considering the candidate classification, the strategy selection section 202 may select, in a case where the document to be classified satisfies a predetermined condition, a generation strategy that corresponds to the predetermined condition. In this case, a condition for the document to be classified need only be associated with each of the generation strategies. This brings about not only the example advantage brought about by the document classification apparatus 1 according to the first example embodiment but also an example advantage of making it possible to select a generation strategy suitable for the document to be classified.

Alternatively, instead of considering the document to be classified, the strategy selection section 202 may select, in a case where the candidate classification satisfies a predetermined condition, a generation strategy that corresponds to the predetermined condition. In this case, a condition for the candidate classification need only be associated with each of the generation strategies. This brings about not only the example advantage brought about by the document classification apparatus 1 according to the first example embodiment but also an example advantage of making it possible to select a generation strategy suitable for the candidate classification.

Further, no application condition is associated with the generation strategy 3 illustrated in FIG. 5. For a general-purpose generation strategy, no application condition may be set as in the case of the generation strategy 3. For example, in a case where there is no generation strategy that satisfies an application condition, the strategy selection section 202 may select a generation strategy for which no application condition is set. Further, for example, the strategy selection section 202 may unconditionally select a generation strategy for which no application condition is set, and may select, in addition to the generation strategy, a generation strategy that satisfies an application condition.

Note that a method of generating a hypothetical sentence is not limited to the above example. For example, the hypothetical sentence generation section 203 may generate a hypothetical sentence with use of a document generation model that outputs a document related to a character string such as a word or a sentence by receiving an input of the character string. For example, an encoder-decoder model or the like can be applied to the document generation model. The encoder-decoder model that is applied here outputs a hypothetical sentence related to input text data by encoding the input text data (e.g., converting the input text data into a vector) and decoding data obtained by conversion (returning the data to text data).

In a case where the document generation model is applied, it is only necessary to prepare, in advance, a plurality of document generation models (e.g., such an encoder-decoder model as described above) that are in accordance with attribute information (e.g., a category, an extraction source, and/or the like) of the document to be classified and/or attribute information of the candidate classification. This allows a document that is in accordance with the document to be classified and/or the candidate classification to be generated by applying a document generation model that is in accordance with the document to be classified and/or the candidate classification. In this case, selecting the document generation model that is in accordance with at least one of the document to be classified and the candidate classification corresponds to selecting the generation strategy.

Further, a document generation model called a conditional encoder-decoder into which a topic, etc. can be input as a condition may also be applied. In this case, by inputting a condition that is in accordance with the document to be classified and/or the candidate classification, it is possible to generate a document corresponding to the document to be classified and/or the candidate classification. In this case, determining the condition that is in accordance with at least one of the document to be classified and the candidate classification corresponds to selecting the generation strategy.

### (Language Understanding Model)

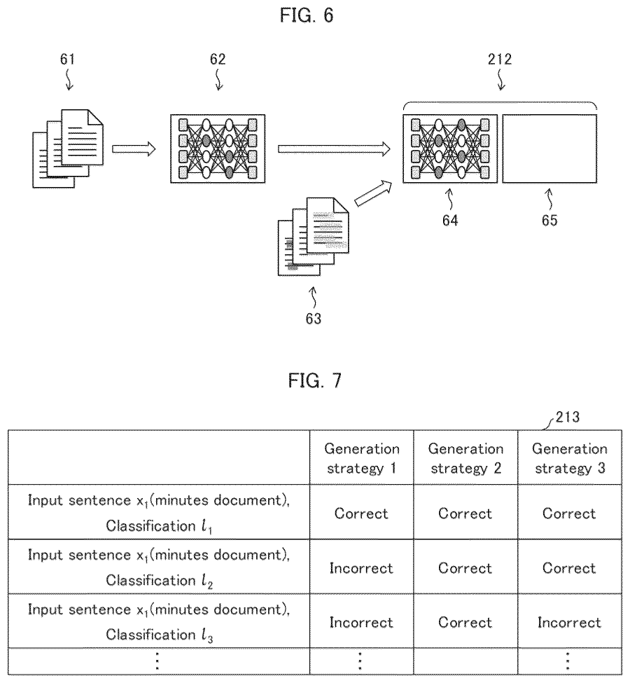

The language understanding model 212 is a model constructed so as to output an entailment score when a set of a hypothetical sentence and a document which set is to be evaluated is input, the entailment score being an index value indicating a degree to which the document entails the hypothetical sentence. The following description will discuss, with reference to FIG. 6, a method for generating the language understanding model 212. FIG. 6 is a view illustrating the method for generating the language understanding model 212.

The language understanding model 212 may be a combination of (i) a pretrained language model that converts a document into a vector which is in accordance with a context of the document and (ii) a language task model that classifies a document. In this case, a document to be classified and a hypothetical sentence are converted into respective vectors by the pretrained language model, and an entailment score indicating a degree to which the document to be classified entails the hypothetical sentence is calculated from these vectors by the language task model.

In a case where such a language understanding model 212 is generated, first, a pretrained language model 62 is generated from a large amount of text data 61, as illustrated in FIG. 6. A self-supervised learning method is preferably used to generate the pretrained language model 62. This makes it possible to, without labeling the text data with ground truth data, carry out learning for converting a document into a vector that is in accordance with a context of the document. For example, enormous text data on a web can be used as it is for learning.

Next, labeled training data 63 is used to generate a language task model 65 for classifying the vectors generated by the pretrained language model 62. Specifically, as the training data 63, it is only necessary to apply training data obtained by assigning, to a set of a hypothetical sentence and a document for which it is known whether the document entails the hypothetical sentence, a label indicating whether the document of the set entails the hypothetical sentence. Examples of the training data 63 that can be used include Stanford Natural Language Inference (SNLI) and Cross-lingual Natural Language Inference (XNLI).

This makes it possible to generate the language understanding model 212 that outputs an output value indicating, by, for example, a numerical value of 1 to 0, a degree to which an input document entails an input hypothetical sentence. As illustrated in FIG. 6, instead of using the pretrained language model 62 as it is, by using the training data 63 to tune the pretrained language model 62, it is possible to use a pretrained language model 64 with higher suitability to the language task model 65.

(Evaluation in Case where Plurality of Hypothetical Sentences are Generated)

The strategy selection section 202 may select a plurality of generation strategies. Further, in this case, the hypothetical sentence generation section 203 may generate a plurality of hypothetical sentences with use of the generation strategies. The classification section 204 may carry out evaluation with use of each of the generated hypothetical sentences and calculate an evaluation result obtained by aggregating results of the evaluation.

Assume, for example, that, in a case where appropriateness of classification of the document x as the candidate classification 1 is evaluated, the strategy selection section 202 selects 100 generation strategies, and the hypothetical sentence generation section 203 uses those generation strategies to generate 100 hypothetical sentences. In this case, the classification section 204 inputs a set of the document x and a hypothetical sentence into the language understanding model 212, and calculates entailment scores (a total of 100 entailment scores) of the respective hypothetical sentences. Then, the classification section 204 aggregates those entailment scores and calculates an index value indicating appropriateness of classification of the document x as the candidate classification 1 (hereinafter referred to as “aggregate score”).

A method of calculating the aggregate score is not particularly limited provided that the method is such a method which allows the aggregate score in which at least some of the calculated entailment scores are reflected to be calculated. For example, the classification section 204 may calculate, as the aggregate score, a statistic calculated from the entailment scores calculated for the respective plurality of hypothetical sentences. Note that the statistic is a numerical value which has been obtained by application of a statistical algorithm and in which feature values of data are summed up. Examples of the statistic include an arithmetic mean value, a mode, a median, a maximum value, and a minimum value.

Alternatively, instead of calculating such an aggregate score as described above, the classification section 204 may output a plurality of calculated entailment scores as a classification result. In this case, those entailment scores allow a user of the document classification apparatus 2 to recognize an appropriate classification as which the document to be classified is to be classified.

### (Generation Strategy Selection Method Based on History Information)

The strategy selection section 202 may select a generation strategy on the basis of the history information 213. The following description will discuss, with reference to FIG. 7, selection of the generation strategy on the basis of the history information 213. FIG. 7 is a view illustrating an example of the history information 213.

The history information 213 is information indicating whether a result of document classification previously carried out is correct, and is recorded by the history recording section 205. Thus, it can be said that a generation strategy selection method based on the history information 213 is based on a result of document classification previously carried out and is a selection method using a learning base.

The history information 213 illustrated in FIG. 7 indicates, for document classification carried out by application of each of the generation strategies 1 to 3, a classified document, a classification as which the classified document has been classified, and correctness or incorrectness of the classification. Specifically, the history information 213 of FIG. 7 indicates, for a combination of an input sentence x₁ and each of classifications 11 to 13, a result of determination of correctness or incorrectness for evaluation of appropriateness of each of the generation strategies used.

For example, for a combination of the input sentence x₁ and the classification 11, a result of determination of correctness or incorrectness in a case where a hypothetical sentence is generated in accordance with the generation strategy 1 is “correct”. This indicates that, by generating a hypothetical sentence concerning the classification 11 in accordance with the generation strategy 1, appropriateness of classification of the input sentence x₁ as the classification 11 was able to be correctly evaluated, i.e., an appropriate entailment score was calculated.

In contrast, for a combination of the input sentence x₁ and the classification 12, a result of determination of correctness or incorrectness in a case where a hypothetical sentence is generated in accordance with the generation strategy 1 is “incorrect”. This indicates that, in a case where a hypothetical sentence concerning the classification 12 was generated in accordance with the generation strategy 1, appropriateness of classification of the input sentence x₁ as the classification 12 was unable to be correctly evaluated, i.e., no appropriate entailment score was calculated.

For each of combinations of a document and a classification which combinations have been evaluated by the classification section 204, the history recording section 205 can generate such history information 213 by causing, for example, a user to input correctness or incorrectness of a result of the evaluation or a classification result.

Such history information 213 serves as a principle that guides which generation strategy to select when which input sentence and which classification are combined. Thus, for a combination of a document to be classified and a candidate classification as which the document to be classified is to be classified, the strategy selection section 202 can select, on the basis of the history information 213, a generation strategy for which it is considered possible to correctly evaluate appropriateness of classification of the document to be classified.

For example, the strategy selection section 202 may select a generation strategy on the basis of a rate at which an appropriate entailment score is calculated when the generation strategy is applied (hereinafter referred to as “accuracy”). For example, the strategy selection section 202 may select a predetermined number of generation strategies with high ranking accuracies.

Further, the history information 213 of FIG. 7 shows that the input sentence x₁ is a minutes document. The history recording section 205 may thus include, in the history information 213, attribute information indicating what type of document the input sentence x₁ is. In this case, the strategy selection section 202 may select a generation strategy on the basis of an accuracy of an input sentence with which attribute information identical to the attribute information of the document to be classified is associated. For example, in a case where the document to be classified is a medical-related document, the strategy selection section 202 may select a generation strategy whose accuracy of a medical-related input sentence is high.

Similarly, the history recording section 205 may include attribute information of a classification in the history information 213. In this case, the strategy selection section 202 can select a generation strategy on the basis of an accuracy for a classification whose attribute information is identical to that of the candidate classification as which the document to be classified is to be classified. For example, in a case where the candidate classification is a hobby, the strategy selection section 202 can select a generation strategy whose accuracy is high when the classification is a hobby.

As described above, the strategy selection section 202 may select the at least one generation strategy on the basis of the history information 213 indicating whether a result of document classification previously carried out is correct. This configuration brings about not only the example advantage brought about by the document classification apparatus 1 according to the first example embodiment but also an example advantage of making it possible to select a generation strategy that is considered appropriate in view of history information.

### (Flow of Process)

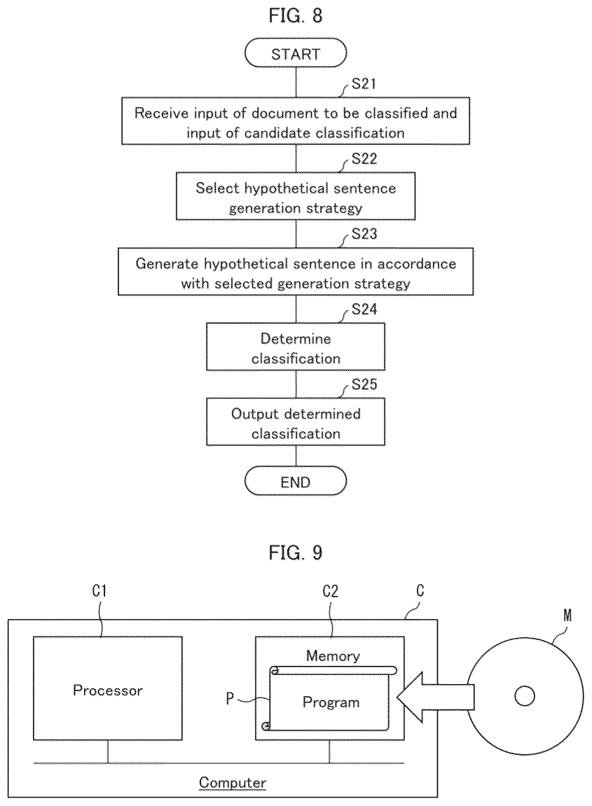

The following description will discuss, with reference to FIG. 8, a flow of a process (document classification method) carried out by the document classification apparatus 2. FIG. 8 is a flowchart showing the flow of the process carried out by the document classification apparatus 2.

In S21, the data acquisition section 201 receives an input of a document to be classified and an input of a candidate classification. Any text data can be applied as the document to be classified. One or more candidate classifications may be input. For example, the data acquisition section 201 may receive, as the candidate classification, an input of a label set L including a plurality of classification labels 1.

In S22, the strategy selection section 202 selects at least one generation strategy from among a plurality of generation strategies for generating a hypothetical sentence related to a candidate classification as which a document is to be classified. For example, the strategy selection section 202 selects at least one generation strategy from among generation strategies recorded in the generation strategy holding section 211.

In a case where the label set L including the plurality of classification labels 1 has been input in S21, the strategy selection section 202 may select, for each of the classification labels, a generation strategy that is in accordance with a corresponding classification label. A generation strategy selection method may be a selection method using a rule base, as described in “Generation strategy and generation strategy selection method”, or may be a selection method using a learning base, as described in “Generation strategy selection method based on history information”.

In S23, the hypothetical sentence generation section 203 generates, in accordance with the at least one generation strategy selected in S22, a hypothetical sentence concerning the candidate classification the input of which has been received in S21. In a case where a plurality of generation strategies have been selected in S22, the hypothetical sentence generation section 203 generates a plurality of hypothetical sentences in accordance with the generation strategies. Assume, for example, that, in S22, the generation strategies 1 and 3 are selected as the generation strategies corresponding to a classification label 11, and the generation strategies 2 and 3 are selected as generation strategies corresponding to a classification label 12. In this case, for one classification label 11, the hypothetical sentence generation section 203 generates a hypothetical sentence in accordance with the generation strategy 1, and generates a hypothetical sentence in accordance with the generation strategy 3. Similarly, for one classification label 12, the hypothetical sentence generation section 203 generates a hypothetical sentence in accordance with the generation strategy 2, and generates a hypothetical sentence in accordance with the generation strategy 3.

In S24, the classification section 204 determines a classification as which the document to be classified the input of which has been received in S21 is to be classified. For example, the classification section 204 may calculate an entailment score by inputting, into the language understanding model 212, a set of a hypothetical sentence and the document to be classified. The entailment score, which indicates appropriateness of classification of the document to be classified as the candidate classification the input of which has been received in S21, can be said to indicate the classification as which the document to be classified is to be classified. In a case where a plurality of hypothetical sentences have been generated in S23, the process in S24 is carried out with respect to each of the plurality of hypothetical sentences. In a case where a plurality of hypothetical sentences are generated for one candidate classification and entailment scores are calculated for the generated respective hypothetical sentences, the classification section 204 may calculate an aggregate score from those entailment scores, as described in “Evaluation in case where plurality of hypothetical sentences are generated” described earlier.

In S25, the classification section 204 causes the output section 23 to output the classification determined by the process in S24. For example, the classification section 204 may cause the output section 23 to output, as the determined classification, the candidate classification whose entailment score or aggregate score exceeds a threshold. This ends the process in FIG. 8.

In S25, the classification section 204 may output the entailment score or the aggregate score of the candidate classification. In this case, from the output aggregate score, the user of the document classification apparatus 2 can determine, for example, as which of the candidate classifications the sentence to be classified is to be classified, or not to classify the sentence to be classified as any of the candidate classifications. As a matter of course, it is not always necessary to output any evaluation result or any classification. The classification section 204 may store the calculated evaluation result and/or the determined classification in, for example, the storage section 21 so as to end the process.

### [Variation]

The processes described in the foregoing example embodiments may be carried out by any entity, which is not limited to the foregoing examples. That is, a document classification system having functions similar to the functions of the document classification apparatus 2 can be constructed by a plurality of apparatuses that can communicate with each other. For example, a document classification system having functions similar to the functions of the document classification apparatus 2 can be constructed by dispersedly providing, in a respective plurality of apparatuses, blocks illustrated in FIG. 4.

### Software Implementation Example

Some or all of the functions of the document classification apparatus 2 may be realized by hardware such as an integrated circuit (IC chip) or may be alternatively realized by software. In the latter case, the document classification apparatus 2 is realized by, for example, a computer that executes instructions of a program that is software realizing the foregoing functions. FIG. 9 illustrates an example of such a computer (hereinafter referred to as “computer C”). The computer C includes at least one processor C1 and at least one memory C2. The memory C2 stores a program P for causing the computer C to operate as the document classification apparatus 2. In the computer C, the functions of the document classification apparatus 2 are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface via which the computer C transmits/receives data to/from another apparatus. The computer C may further include an input/output interface via which the computer C is connected to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

A document classification apparatus including: a strategy selection means that selects at least one generation strategy from among a plurality of generation strategies for generating a hypothetical sentence related to a candidate classification as which a document is to be classified; a hypothetical sentence generation means that generates, in accordance with the at least one generation strategy selected by the strategy selection means, the hypothetical sentence, which is a sentence related to the candidate classification; and a classification means that determines, on the basis of entailment between the document and the hypothetical sentence, a classification as which the document is to be classified.

### (Supplementary Note 2)

The document classification apparatus according to Supplementary note 1, wherein, in a case where the document satisfies a predetermined condition, the strategy selection means selects the at least one generation strategy that corresponds to the predetermined condition.

### (Supplementary Note 3)

The document classification apparatus according to Supplementary note 1 or 2, wherein, in a case where the candidate classification satisfies a predetermined condition, the strategy selection means selects the at least one generation strategy that corresponds to the predetermined condition.

### (Supplementary Note 4)

The document classification apparatus according to Supplementary note 1, wherein, in a case where at least one of the document and the candidate classification satisfies a predetermined condition, the strategy selection means selects the at least one generation strategy that corresponds to the predetermined condition.

### (Supplementary Note 5)

The document classification apparatus according to Supplementary note 1, wherein the strategy selection means selects the at least one generation strategy on the basis of history information indicating whether a result of document classification previously carried out is correct.

### (Supplementary Note 6)

A document classification method including: (a) selecting at least one generation strategy from among a plurality of generation strategies for generating a hypothetical sentence related to a candidate classification as which a document is to be classified; (b) generating, in accordance with the selected at least one generation strategy, the hypothetical sentence, which is a sentence related to the candidate classification; and (c) determining, on the basis of entailment between the document and the hypothetical sentence, a classification as which the document is to be classified, (a), (b), and (c) each being carried out by at least one processor.

### (Supplementary Note 7)

A document classification program for causing a computer to function as: a strategy selection means that selects at least one generation strategy from among a plurality of generation strategies for generating a hypothetical sentence related to a candidate classification as which a document is to be classified; a hypothetical sentence generation means that generates, in accordance with the at least one generation strategy selected by the strategy selection means, the hypothetical sentence, which is a sentence related to the candidate classification; and a classification means that determines, on the basis of entailment between the document and the hypothetical sentence, a classification as which the document is to be classified.

### [Additional Remark 3]

The whole or part of the example embodiments disclosed above further can also be expressed as below. A document classification apparatus including at least one processor, the at least one processor carrying out: a strategy selection process for selecting at least one generation strategy from among a plurality of generation strategies for generating a hypothetical sentence related to a candidate classification as which a document is to be classified; a hypothetical sentence generation process for generating, in accordance with the at least one generation strategy selected by the strategy selection process, the hypothetical sentence, which is a sentence related to the candidate classification; and a classification process for determining, on the basis of entailment between the document and the hypothetical sentence, a classification as which the document is to be classified.

Note that the document classification apparatus may further include a memory, which may store a program for causing the at least one processor to carry out the strategy selection process, the hypothetical sentence generation process, and the classification process. The program may be stored in a non-transitory tangible computer-readable storage medium.

### REFERENCE SIGNS LIST

1, 2 Document classification apparatus
11, 202 Strategy selection section
12, 203 Hypothetical sentence generation section
13, 204 Classification section

What is claimed is:

1. A document classification apparatus comprising at least one processor, the processor carrying out:
a strategy selection process for selecting at least one generation strategy from among a plurality of generation strategies for generating a hypothetical sentence related to a candidate classification as which a document is to be classified;
a hypothetical sentence generation process for generating, in accordance with the at least one generation strategy selected by the strategy selection process, the hypothetical sentence, which is a sentence related to the candidate classification; and
a classification process for determining, on the basis of entailment between the document and the hypothetical sentence, a classification as which the document is to be classified.

2. The document classification apparatus according to claim 1, wherein, in a case where the document satisfies a predetermined condition, in the strategy selection means process, the at least one processor selects the at least one generation strategy that corresponds to the predetermined condition.

3. The document classification apparatus according to claim 1, wherein, in a case where the candidate classification satisfies a predetermined condition, in the strategy selection process, the at least one processor selects the at least one generation strategy that corresponds to the predetermined condition.

4. The document classification apparatus according to claim 1, wherein, in a case where at least one of the document and the candidate classification satisfies a predetermined condition, in the strategy selection process, the at least one processor selects the at least one generation strategy that corresponds to the predetermined condition.

5. The document classification apparatus according to claim 1, wherein in the strategy selection process, the at least one processor selects the at least one generation strategy on the basis of history information indicating whether a result of document classification previously carried out is correct.

6. A document classification method comprising:
(a) selecting at least one generation strategy from among a plurality of generation strategies for generating a hypothetical sentence related to a candidate classification as which a document is to be classified;
(b) generating, in accordance with the selected at least one generation strategy, the hypothetical sentence, which is a sentence related to the candidate classification; and
(c) determining, on the basis of entailment between the document and the hypothetical sentence, a classification as which the document is to be classified, (a), (b), and (c) each being carried out by at least one processor.

7. A non-transitory storage medium storing a document classification program for causing a computer to carry out:
a strategy selection process for selecting at least one generation strategy from among a plurality of generation strategies for generating a hypothetical sentence related to a candidate classification as which a document is to be classified;
a hypothetical sentence generation process for generating, in accordance with the at least one generation strategy selected by the strategy selection process, the hypothetical sentence, which is a sentence related to the candidate classification; and
a classification process for determining, on the basis of entailment between the document and the hypothetical sentence, a classification as which the document is to be classified.
